(19) United States
(12) Patent Application Publication
(10) Pub. No.: US 2006/0024228 A1
(43) Pub. Date: Feb. 2, 2006

(54) Methods of fabricating photocatalytic antibacterial polyester grains and textiles

(75) Inventors: Nai-Yun Liang, Taipei City (TW); Liao-Feng Chang, Taipei City (TW)

Correspondence Address: William B. Patterson;Moser, Patterson & Sheridan, L.L.P., Suite 1500, 3040 Post Oak Boulevard, Houston, TX, 77056, US

(73) Assignee: TAIWAN TEXTILE RESEARCH INSTITUTE

(21) Appl. No.: 11/037,586

(22) Filed: Jan. 18, 2005

(30) Foreign Application Priority Data
Aug. 2, 2004 (TW) 93123141

(51) Int. Cl. C01G 23/047

(52) U.S. Cl. 423/610

(57) ABSTRACT

Titanium dioxide nanoparticles are prepared in liquid phase at a low temperature. The titanium dioxide nanoparticles can be added into polyester to prepare polyester grains having a photocatalytic antibacterial property. Furthermore, a textile can be dipped into a solution containing the titanium dioxide nanoparticles to obtain a photocatalytic antibacterial textile.

### CROSS-REFERENCE TO RELATED APPLICATIONS

The present application is based on, and claims priority from, Taiwan Application Serial Number 93123141, filed on Aug. 2, 2004, the disclosure of which is hereby incorporated by reference herein in its entirety.

### BACKGROUND OF THE INVENTION

1. Field of the Invention

The present invention relates to a method of producing antibacterial fibers and textiles. More particularly, the present invention relates to a method of producing photocatalytic antibacterial fibers and textiles.

2. Description of the Related Art

There are two types of fibers used in textiles: natural fibers and synthetic fibers. Along with the advancing of scientific technology, research and development of new materials keep increasing new varieties of fibers. Since the physical and chemical properties of synthetic fibers are close to or even superior to those of natural fibers, consumers acceptance of synthetic fibers has readily increased. Hence, synthetic fibers have become more and more important in the market.

With advances in human lifestyle, new requirements for the fibers' functions have been generated. Various functional fibers, such as anti-static fibers, flame retarded fibers, and antibacterial fibers, are continuously being created, wherein the antibacterial fibers are very much a part of everyday human life.

The earliest application of antibacterial textiles was during the Second World War. The German army wore regimentals subjected to antibacterial treatment; and the infected percentage of injured persons was thus largely decreased. After the 1960s, antibacterial technology was applied to the textiles used in daily life. The antibacterial agents used in the antibacterial treatment include organic tin and chlorophenol, which both have strong disinfectant ability. Although the antibacterial agents described above have strong disinfectant ability, they are also highly toxic. Since the 1980s, quaternary ammonium salts have been used in the antibacterial treatment of textiles to increase the safety of the antibacterial textiles. However, the antibacterial effect of these textiles decreases rapidly.

Antibacterial agents used in commercial textiles can be divided into two groups. One group is organic compounds including quaternary ammonium salts. The other group is inorganic compounds including metal ions, such as Ag⁺, Zn²⁺, and Cu²⁺, and metal particles, such as silver particles. The methods of producing such antibacterial textiles mostly comprise dipping and padding. Consequently, the antibacterial textiles have the following drawbacks. First, the washing endurance of the antibacterial textiles is not good. Second, the stability of the antibacterial is poor. Third, the user is easily allergic to the antibacterial agents on the textiles.

### SUMMARY OF THE INVENTION

In one aspect, the present invention provides a photocatalytic antibacterial agent and a production method thereof to increase the stability and antibacterial ability of the agent. At the same time, the amount of the antibacterial agent used is also decreased.

In another aspect, the present invention provides photocatalytic antibacterial polyester grains and a producing method thereof. The amount of photocatalytic antibacterial agent needed to achieve the same performance as other agents is less, and the stability of the photocatalytic antibacterial agent produced by the method disclosed in this invention is better, too.

In yet another aspect, the present invention provides a photocatalytic antibacterial textile and a producing method thereof to increase the washing durability and the antibacterial ability.

In accordance with the foregoing and other aspects of the present invention, a method of producing a photocatalytic antibacterial agent is provided. The method comprises the following steps. A titanium compound and an alcohol solvent are mixed to form a prepared solution, and the titanium compound includes a titanium salt and a titanium alkoxide. Water is added to the prepared solution to hydrolyze the titanium compound to form titanium hydroxide precipitate. An acid is added into the titanium hydroxide solution to peptize the titanium hydroxide precipitate and form titanium dioxide crystallite. Then, the titanium dioxide crystallite solution is refluxed to transform the titanium dioxide crystallite into titanium dioxide sol possessing the photocatalytic ability. The content of titanium dioxide in the sol is about 100 ppm to 5% by weight.

According to a preferred embodiment of the present invention, the titanium salt comprises TiCl₄, and the titanium alkoxide is Ti(OC₂H₅)₄, Ti(OC₃H₇)₄ or Ti(OC₄H₉)₄. The alcohol solvent is ethanol, propanol or butanol, and the acid is HNO₃ or HCl. The heating proceeds at a temperature of about 60-100° C. for 3-12 hours.

According to another preferred embodiment of the present invention, a metal salt, used as a dopant, is added before hydrolysis reaction. The metal salt is a metal nitrate, a metal sulfate or a metal chloride, and the metal ion is Cr, Mn, Fe, Cu, Zn, V, Ag, Co, La, Ce or any combination thereof.

In accordance with the foregoing and other aspects of the present invention, a method of producing photocatalytic antibacterial polyester grains is provided. The titanium dioxide sol prepared by the method described above is mixed with polyester material. The mixture is dried by heating and then is compounded to form photocatalytic antibacterial polyester composite. The photocatalytic antibacterial polyester composite is then cooled and cut to form polyester grains. The concentration of titanium dioxide in the photocatalytic antibacterial polyester grains is about 100-5000 ppm.

According to a preferred embodiment of the present invention, the polyester is polybutylene terephthalate or polyethylene terephthalate. The drying proceeds at a temperature of about 80-110° C. for 4-24 hours.

In accordance with the foregoing and other aspects of the present invention, a method of producing a photocatalytic antibacterial textile is provided. A textile is dipped in the titanium dioxide sol prepared by the method described above. The textile is then padded. The dipping and the padding steps are repeated several times. The textile is then dried to obtain a photocatalytic antibacterial textile.

According to a preferred embodiment, the concentration of titanium dioxide particles in the sol is at least 100 ppm and the drying temperature is about 50-110° C.

In the foregoing, the preferred embodiments of the present invention synthesize the doped or undoped titanium dioxide nanoparticles in the liquid phase at a low temperature to provide a photocatalytic antibacterial agent that can absorb ultraviolet and/or visible light. Since the particle size is smaller than that of titanium dioxide particles prepared by conventional calcination, the specific surface area per unit weight of titanium dioxide is much larger than that of conventional titanium dioxide particles. Therefore, the amount of the titanium dioxide nanoparticles needed for producing antibacterial polyester grains and textiles can be largely reduced while still maintaining the original properties of the polyester grains and textiles. Consequently, the polyester grains and the textiles can be easily processed later and still obtain the photocatalytic antibacterial ability of titanium dioxide.

It is to be understood that both the foregoing general description and the following detailed description are made by examples and are intended to provide further explanation of the invention as claimed.

### BRIEF DESCRIPTION OF THE DRAWINGS

The accompanying drawings are included to provide a further understanding of the invention and are incorporated in and constitute a part of this specification. The drawings illustrate embodiments of the invention and, together with the description, serve to explain the principles of the invention. In the drawings,

FIG. 1 is a ultraviolet/visible light absorption spectrum of a Cr³⁺/TiO₂ photocatalyst powders prepared according to a preferred embodiment of this invention; and

FIG. 2 is a diagram showing the pressure test result of antibacterial polyester grains prepared according to a preferred embodiment of this invention.

### DETAILED DESCRIPTION OF THE PREFERRED EMBODIMENT

Reference will now be made in detail to the present preferred embodiments of the invention, examples of which are illustrated in the accompanying drawings.

Low-Temperature Preparing Method of Titanium Dioxide Nanoparticles

A titanium compound, such as a titanium salt or a titanium alkoxide, is uniformly mixed with an alcohol solvent to form a prepared solution. Then, a large amount of pure water is added to the prepared solution to hydrolyze the titanium compound. Titanium hydroxide precipitate is immediately formed after adding the water. After the hydrolysis reaction is complete, an acid is added to the titanium hydroxide solution to peptize the titanium hydroxide precipitate and form titanium dioxide crystallite. The solution containing the titanium dioxide crystallite is heated and refluxed in an oil bath at about 60-100° C. for 3-12 hours to obtain titanium dioxide sol. The titanium dioxide sol is photocatalytic, and the absorption wavelength is within the ultraviolet light range.

In the method described above, the titanium salt is, for example, TiCl₄. The titanium alkoxide is, for example, Ti(OC₂H₅)₄, Ti(OC₃H₇)₄ or Ti(OC₄H₉)₄ and the acid is, for example, HNO₃ or HCl. The amount of the water used to hydrolyze the titanium compound is about 60-5000 times the molar quantity of the titanium compound. The alcohol solvent is, for example, ethanol, propanol or butanol. The concentration of the obtained titanium dioxide sol is preferably about 1000 ppm to about 5% by weight.

A preferred embodiment is described below for exemplary purposes only 0.125 moles of Ti(OC₄H₉)₄, 0.375 moles of isopropanol, and 450 mL of pure water were mixed first. Then, a trace amount of HNO₃ was added to peptize the resulting titanium hydroxide precipitate for three days. Finally, the solution was heated and refluxed at 90° C. for 4 hours to obtain titanium dioxide sol. That is, is the titanium dioxide nanoparticles uniformly dispersed in an aqueous solution was obtained.

In light of the foregoing, a preferred embodiment of the present invention provides a low-temperature producing method for preparing titanium dioxide nanoparticles to be a photocatalytic antibacterial agent. Conventionally, titanium dioxide particles can be obtained only through high-temperature calcination, and the particle size of the titanium dioxide particles is in the micrometer order. Therefore, for titanium dioxide of the same weight, the titanium dioxide nanoparticles prepared by the preferred embodiment of this invention have larger reaction surface area than the conventional titanium dioxide particles. Consequently, when the titanium dioxide nanoparticles are used as an additive to fibers or textiles, the amount needed can be largely reduced.

Low-Temperature Preparing Method of Doped Titanium Dioxide Nanoparticles

A titanium compound, such as a titanium salt or a titanium alkoxide, and a metal salt are uniformly mixed with an alcohol solvent to form a prepared solution. Then, a large amount of pure water is added to the prepared solution to hydrolyze the titanium compound. Titanium hydroxide precipitate is immediately formed after adding the water. After the hydrolysis reaction is complete, an acid is added to the titanium hydroxide solution to peptize the titanium hydroxide precipitate and form titanium dioxide crystallite. The solution containing the titanium dioxide crystallite is heated and refluxed in an oil bath at about 60-100° C. for 3-12 hours to obtain doped titanium dioxide sol. The titanium dioxide sol is photocatalytic, and the absorption wavelength is not only is within the ultraviolet range, the absorbance in the visible range is also largely elevated. Hence, the photocatalytic activity of the doped titanium dioxide nanoparticles is higher than that of the undoped.

In the method described above, the titanium salt is, for example, TiCl₄. The titanium alkoxide is, for example, Ti(OC₂H₅)₄, Ti(OC₃H₇)₄ or Ti(OC₄H₉)₄. The metal salt anion is, for example, a nitrate, a sulfate or a chloride anion; and the metal salt cation is, for example, a cation of Cr, Mn, Fe, Cu, Zn, V, Ag, Go, La, Ce or any combination thereof. The amount of the metal salt added is preferably about 0.01% to about 1% of the titanium compound by mole quantity. Hence, the titanium dioxide nanoparticles can absorb visible light to catalyze the photocatalytic reaction. The acid is, for example, HNO₃ or HCl. The amount of water added to hydrolyze the titanium compound is about 60-5000 times the molar quantity of the titanium compound. The alcohol solvent is, for example, ethanol, propanol or butanol.

The structure of the doped titanium dioxide nanoparticles is such that the dopant metal ions can locate on the surfaces of the titanium dioxide nanoparticles. Hence, the dopant metal ions can help the titanium dioxide absorb visible light and transfer the energy to the titanium dioxide to proceed the photocatalytic reaction. For example, the d-orbital electrons of the dopant metal ions can transit to the conductive band of the titanium dioxide nanoparticles, and the light absorption property of the titanium dioxide nanoparticles is thus changed. It is also possible that the dopant metal ions replace some of the titanium ions to become photocatalytic centers, which are responsible for visible light absorption.

A preferred embodiment is described below for exemplary purposes only. 3.125×10⁻³ moles of Ti(OC₄H₉)₄, 1.5×10⁻⁵ moles of Cr(NO₃)₃9H₂O, 0.01 moles of isopropanol, and 450 mL of pure water were mixed first. Then, a trace amount of HNO₃ was added to peptize the resulting titanium hydroxide precipitate for three days. Finally, the solution was heated and refluxed at 60° C. for 12 hours to obtain Cr³⁺/TiO₂ sol. The concentration of the Cr³⁺/TiO₂ sol was about 500 ppm.

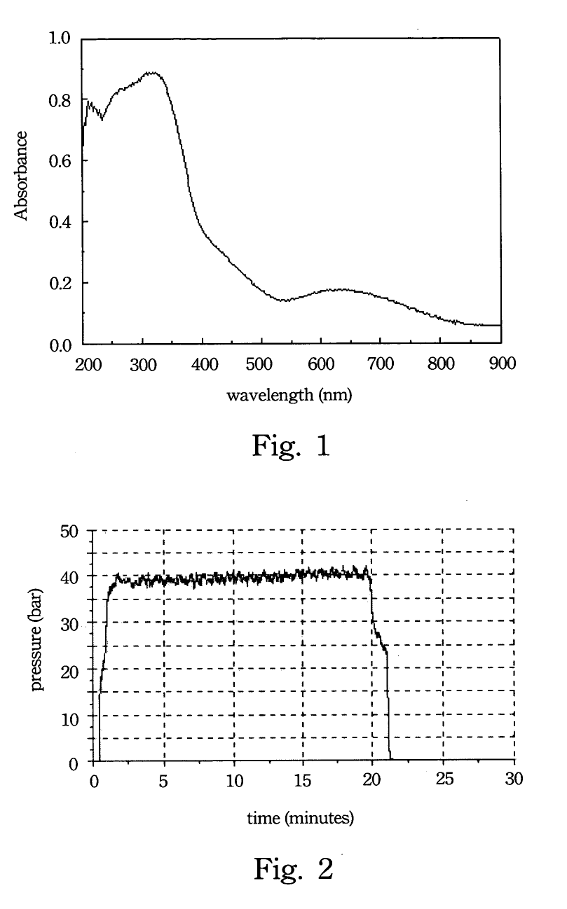

After drying the Cr³⁺/TiO₂ sol, the ultraviolet/visible light absorption spectrum was measured. The obtained spectrum is shown in FIG. 1. The vertical axis of FIG. 1 represents light absorbance and the horizontal axis represents light wavelength. By analyzing FIG. 1, an absorption peak is noted in the visible range. Hence, the Cr³⁺/TiO₂ powder is a visible-light responsive photocatalyst.

In light of the foregoing, the preferred embodiment of the present invention provides a low-temperature preparing method to prepare doped titanium dioxide nanoparticles, which can absorb both ultraviolet and visible light. Therefore, the doped titanium dioxide nanoparticles can absorb ultraviolet light and visible light to proceed the photocatalytic reaction for achieving antibacterial purposes.

A Preparing Method of Antibacterial Polyester Grains, Fibers and Textiles

Polyester is uniformly mixed with doped or undoped TiO₂ sol, which is prepared by the methods described above. The mixture is dried by heating at a temperature of about 80-110° C. for about 4-24 hours. The dried mixture of polyester and titanium dioxide is delivered into a twin screw extruder to is perform a high-temperature compounding process. After compounding and extruding, the compounded polyester is cooled and then cut to obtain antibacterial polyester grains containing doped or undoped titanium dioxide photocatalyst.

The doped or undoped titanium dioxide concentration of the obtained 20 antibacterial polyester grains is preferably 100-5000 ppm by weight. For example, 10 kg of polyester can be mixed with 500 mL of about 2% of doped or undoped titanium dioxide sol by weight. After the compounding, cooling and cutting processes, antibacterial polyester grains are obtained.

The polyester described above is polybutylene terephthalate (PBT) or polyethylene terephthalate (PET).

Next, the dispersion level of titanium dioxide nanoparticles in the polyester grains is tested to see whether the antibacterial polyester grains are suitable to be spun or not. The testing method consists of delivering the antibacterial polyester grains into an extruder to perform a high-temperature compounding process. After melting, the antibacterial polyester grains are allowed to penetrate a sieve. If the dispersion level of titanium dioxide nanoparticles in the antibacterial polyester grains is not good, the molten polyester will easily block the holes of the sieve. Therefore, the pressure on the polyester entering the sieve will be raised during the testing period.

If the pressure on the polyester entering the sieve is raised less than 10 bar/Kg, the polyester grains are suitable to be spun. The obtained result of the testing described above is shown in FIG. 2. The vertical axis of FIG. 2 represents pressure, and the horizontal axis represents time. FIG. 2 shows that the pressure on the polyester entering the sieve is maintained at about 40 bar without obvious pressure increases during the testing period. Hence, the antibacterial polyester grains prepared by the method described above is suitable to be spun into antibacterial fibers.

The antibacterial polyester grains are then spun by a conventional method. The antibacterial fiber structure is of the sheath-core structure type. That is, the antibacterial polyester grains containing titanium dioxide nanoparticles are spun to be the sheaths of the antibacterial fibers, and polyester grains without titanium dioxide nanoparticles are spun to be the cores of the antibacterial fibers. Therefore, the photocatalyst, i.e. the titanium dioxide nanoparticles, can locate on the surface of the antibacterial fibers to perform a photocatalytic reaction. Moreover, the cost of the antibacterial fibers can be controlled and saved.

The antibacterial fibers described above are used to produce antibacterial textiles, and the antibacterial textiles are subjected to an antibacterial test. For example, the photocatalyst in the sheath of the antibacterial fibers is Cr³⁺/TiO₂, and the concentration of the photocatalyst is about 1000 ppm. The antibacterial test is performed by following the Japanese Industrial Standard, JIS L1902-1998 Antibacterial Test Method of Textiles and Antibacterial Effect. The method uses a sun lamp to illuminate the tested textile sample. The distance between the sun lamp and the textile sample is 70 cm. The tested bacteria are Staphylococcus Aureaus and Klebsiella Pneumoniae, and the test results are listed in the following table.

| | | |
|---|---|---|
| | Ultra-violet | Sun Lamp |
| Tested Item | (20 W*1) | (20 W*2) |

| | | | |
|---|---|---|---|
| Staphylococcus | Bacteriostatic | >5.05 | >5.40 |
| Aureaus | value | | |
| (ATCC 6538P) | Bactericidal value | >3.00 | >3.05 |
| Kiebsiella | Bacteriostatic | >6.26 | 5.84 |
| Pneumoniae | value | | |
| (ATCC 4352) | Bactericidal value | >3.06 | 2.68 |

According to the bacteriostatic standard of the Japanese Association for the Functional Evaluation of Textiles (JAFET), the textile is bacteriostatic when the bacteriostatic value is larger than 2.2, and the textile is bactericidal when the bactericidal value is larger than zero. Hence, from the table above, the bacteriostatic and bactericidal ability of the textiles made by antibacterial fibers described above are outstanding.

In light of the foregoing, a method of producing antibacterial polyester grains and antibacterial fibers provided by the preferred embodiments of the present invention has the following advantages. First, since the photocatalyst added in the polyester powder, for producing antibacterial polyester grains, is titanium dioxide nanoparticles, the amount necessary is only 100-5000 ppm by weight. In comparison, the necessary amount of conventional titanium dioxide powders, of which the particle size is in the micrometer range, is 0.1-25% by weight.

Second, since the necessary amount and particle size of the titanium dioxide nanoparticles are less than for conventional titanium dioxide particles, the antibacterial polyester grains are more suitable for spinning to obtain antibacterial fibers. Moreover, antibacterial textiles made from the antibacterial fibers can preserve more of the textiles' original properties.

Antibacterial Textiles and Method of Producing the Same

White cotton fabric is dipped into the doped or undoped titanium dioxide sol prepared by the methods described above to wet the white cotton fabric. The wetted white cotton fabric is then padded. The dipping and padding steps are repeated several times, and the white cotton fabric is dried in an oven to obtain an antibacterial textile.

The concentration of the doped or undoped titanium dioxide nanoparticles in the sol is preferably at least 100 ppm. The drying temperature is preferably 40-110° C.

According to a preferred embodiment, a white cotton fabric in a size about 21 cm×30 cm was dipped into a TiO₂ or Cr³⁺/TiO₂ sol to completely wet the white cotton fabric. The concentration of TiO₂ or Cr³⁺/TiO₂ in the sol was about 500 ppm. The white cotton fabric was then padded, and the dipping and the padding steps were repeated three times. Next, the white cotton was dried in an oven at about 50° C. to obtain the antibacterial textile.

The antibacterial textiles were then subjected to an antibacterial test, which was performed by following the Japanese Industrial Standard, JIS L 1902-1998 Antibacterial Test Method of Textiles and Antibacterial Effect. The method used a sun lamp to illuminate the tested textile sample. The distance between the sun lamp and the textile sample was 10 cm. The tested bacteria were Staphylococcus Aureaus and Klebsiella Pneumoniae. The test results are listed in the following table.

| | | TiO₂ photocatalyst | | TiO₂ photocatalyst | |
|---|---|---|---|---|---|
| | | (ultraviolet light activated) | | (visible light activated) | |
| | | | After | | After |
| | | Before | washing | Before | washing |
| Tested Item | | washing | 50 times | washing | 50 times |
| Staphylococcus | Bacteriostatic value | >5.59 | 3.60 | >5.59 | 5.76 |
| Aureaus | | | | | |
| (ATCC 6538P) | Bactericidal value | >2.99 | 0.70 | >2.99 | 2.74 |
| Klebsiella | Bacteriostatic value | >5.96 | 4.31 | >5.42 | 6.16 |
| Pneumoniae | | | | | |
| (ATCC 4352) | Bactericidal value | >3.03 | 1.35 | >2.48 | 3.02 |

According to the bacteriostatic standard of the Japanese Association for the Functional Evaluation of Textiles (JAFET), the textile is bacteriostatic when the bacteriostatic value is larger than 2.2, and the textile is bactericidal when the bactericidal value is larger than zero.

Hence, from the table above, the bacteriostatic and bactericidal ability of the antibacterial textiles described above are outstanding. Before washing, the bacteriostatic value of Staphylococcus Aureaus and Klebsiella Pneumoniae for the white cotton fabrics dipped in TiO₂ sol were respectively >5.59 and >5.96 to show obvious bacteriostatic effect. After washing 50 times, the bacteriostatic value of Staphylococcus Aureaus and Klebsiella Pneumoniae for the white cotton fabrics dipped in TiO₂ sol were respectively 3.60 and 4.31, which are still larger than the standard of JAFET, 2.2. This shows that the washing durability of the antibacterial white cotton fabric is good. The bactericidal values of the white cotton fabrics dipped in TiO₂ sol before washing and after washing 50 times are larger than zero to show obvious disinfectant ability, too.

For the white cotton fabrics dipped in Cr³⁺/TiO₂ sol, the bacteriostatic values and the disinfectant values of Staphylococcus Aureaus and Klebsiella Pneumoniae show even more obvious bacteriostatic and bactericidal effect, no matter whether before washing or after washing 50 times.

In conclusion, the washing durability of the antibacterial textiles prepared by dipping and padding provided by the preferred embodiment of the present invention is much better than for conventional ones. The stability of the antibacterial agent, i.e. the doped or undoped titanium dioxide nanoparticles, is also better for and less harmless to the human body.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A method of preparing a photocatalytic antibacterial agent, comprising:
mixing a titanium compound and an alcohol solvent to form a prepared solution, wherein the titanium compound includes a titanium salt or a titanium alkoxide;
adding water to the prepared solution to hydrolyze the titanium compound for forming a titanium hydroxide precipitate;
adding an acid into the titanium hydroxide solution to peptize the titanium hydroxide precipitate for forming titanium dioxide crystallite; and
heating to reflux the titanium dioxide crystallite solution for transforming the titanium dioxide crystallite to titanium dioxide sol.

2. The method of claim 1, wherein a temperature of the heating step is about 60-100° C.

3. The method of claim 1, wherein the heating step proceeds for 3-12 hours.

4. The method of claim 1, wherein the titanium salt comprises TiCl₄.

5. The method of claim 1, wherein the titanium alkoxide is Ti(OC₂H₅)₄, Ti(OC₃H₇)₄ or Ti(OC₄H₉)₄.

6. The method of claim 1, wherein the acid is HNO₃ or HCl.

7. The method of claim 1, wherein an amount of the water in the step of adding water is about 60-5000 times that of the molar quantity of the titanium compound.

8. The method of claim 1, wherein the alcohol solvent is ethanol, propanol or butanol.

9. The method of claim 1, wherein the mixing step further comprises adding a metal salt.

10. The method of claim 9, wherein the metal salt is a metal nitrate, a metal sulfate or a metal chloride.

11. The method of claim 9, wherein the metal ion of the metal salt is selected from a group consisting of Cr, Mn, Fe, Cu, Zn, V, Ag, Go, La, Ce and a combination thereof.

12. A titanium dioxide sol prepared by the method of claim 1.

13. The titanium dioxide sol-gel of claim 12, wherein the titanium dioxide sol contains about 100 ppm to about 5% by weight of titanium dioxide nanoparticles.

14. A method of using the titanium dioxide sol of claim 12 to produce photocatalytic antibacterial polyester grains, the method comprising:
mixing a polyester and the titanium dioxide sol to form a mixture;
drying the mixture by heating;
compounding the mixture to form a photocatalytic antibacterial polyester; cooling the photocatalytic antibacterial polyester; and
cutting the photocatalytic antibacterial polyester to form photocatalytic antibacterial polyester grains.

15. The method of claim 14, wherein the polyester is polybutylene terephthalate or polyethylene terephthalate.

16. The method of claim 14, wherein the drying step proceeds for about 4-24 hours.

17. The method of claim 14, wherein a temperature of the drying step is about 80-110° C.

18. A photocatalytic antibacterial polyester grains prepared by the method of claim 14.

19. The photocatalytic antibacterial polyester grains of claim 18, wherein
a concentration of titanium dioxide in the photocatalytic antibacterial polyester grains is about 100-5000 ppm.

20. A method of using the titanium dioxide sol of claim 12 to prepare a photocatalytic antibacterial textile, the method comprising:
dipping a textile into the titanium dioxide sol until completely wetting the textile;
padding the textile;
repeating the dipping and the padding steps a predetermined number of times; and
drying the textile to obtain a photocatalytic antibacterial textile.

21. The method of claim 20, wherein a concentration of titanium dioxide nanoparticles in the titanium dioxide sol is at least about 100 ppm.

22. The method of claim 20, wherein a temperature of the drying step is about 40-110° C.

23. A photocatalytic antibacterial textile prepared by the method of claim 20.
